(19) United States
(12) Patent Application Publication
(10) Pub. No.: US 2018/0108189 A1
(43) Pub. Date: Apr. 19, 2018

(54) TELEMATICS-BASED VEHICLE VALUE REPORTS

(71) Applicant: GENERAL MOTORS LLC, Detroit, MI (US)

(72) Inventors: Saejin Park, Detroit, MI (US); Kurt B. Hoppe, Chandler, AZ (US); Marco T. Carnevale, Windsor (CA)

(21) Appl. No.: 15/292,785

(22) Filed: Oct. 13, 2016

(51) Int. Cl. G07C 5/08; H04B 1/3822; H04L 29/08; G07C 5/00

(52) U.S. Cl. CPC G07C 5/085; G07C 5/008; H04L 67/12; H04B 1/3822

(57) ABSTRACT

A system and method of providing a telematics-based vehicle value report. The method includes: receiving a vehicle identity at a central facility; wirelessly transmitting a request for vehicle sensor data to a vehicle identified by the received vehicle identity via a wireless carrier system; wirelessly receiving the vehicle sensor data from the identified vehicle via the wireless carrier system; accessing, at a central facility, standard vehicle data values for vehicles within a vehicle group that includes the identified vehicle; constructing a vehicle value report which includes information that is based on a comparison of the received vehicle sensor data with the standard vehicle data values; and electronically transmitting the vehicle value report to a requesting entity. The standard vehicle data values represent baseline values, typical values, or ranges of values for the vehicle sensor data received from the identified vehicle.

### TECHNICAL FIELD

The present invention relates to vehicles and, more particularly, to vehicle telematics units and systems for generating vehicle history reports.

### BACKGROUND

Purchasing a used vehicle involves uncertainty. The overall quality of used vehicles is often affected by their environment and the manner in which they are operated. For example, vehicles operating in mountainous terrain may consume brake pads faster than vehicles operating on flat terrain. Or in another example, vehicles whose owners have skipped oil changes may experience a reduced service life. Prospective purchasers may not easily be able to detect where or how a previous vehicle owner operated the vehicle. It is possible for vehicle service facilities to keep vehicle service records or a collision facility to report repairs to vehicles brought to these facilities, and this information may be provided to a third party content aggregator and then used to generate a vehicle maintenance and/or accident history report. However, these facilities cannot monitor the omission of service, which can be as informative as records of service actually provided. And with respect to service and repair facilities, the importance of a reported vehicle service event or collision repair may depend on the accuracy of a technician-inputted description of service and may unnecessarily cause alarm about the condition of a vehicle when the actual damage may only be minor. It would be helpful to provide vehicle value reports that more accurately reflect the current condition of a vehicle.

### SUMMARY

According to an embodiment of the invention, there is provided a method of providing a telematics-based vehicle value report. The method includes: receiving a vehicle identity at a central facility; wirelessly transmitting a request for vehicle sensor data to a vehicle identified by the received vehicle identity via a wireless carrier system; wirelessly receiving the vehicle sensor data from the identified vehicle via the wireless carrier system; accessing, at a central facility, standard vehicle data values for vehicles within a vehicle group that includes the identified vehicle; constructing a vehicle value report which includes information that is based on a comparison of the received vehicle sensor data with the standard vehicle data values; and electronically transmitting the vehicle value report to a requesting entity. The standard vehicle data values represent baseline values, typical values, or ranges of values for the vehicle sensor data received from the identified vehicle.

According to another embodiment of the invention, there is provided a method of providing a telematics-based vehicle value report. The method includes: identifying from a vehicle group a subset of vehicles based on a common identifier; generating requests at a central facility for one or more categories of vehicle sensor data; wirelessly transmitting the requests from the central facility to the subset of vehicles; wirelessly receiving the one or more categories of vehicle sensor data from at least some of the subset of vehicles via the wireless carrier system; generating one or more standard vehicle data values from the received vehicle sensor data, wherein the standard vehicle data values represent baseline values, typical values, or ranges of values for the vehicle sensor data received from the identified vehicle; constructing a vehicle value report which includes information that is based on a comparison of the received vehicle sensor data with the standard vehicle data values; and electronically transmitting the vehicle value report from the central facility to a requesting entity.

In accordance with another embodiment of the invention, there is provided a system for providing a telematics-based vehicle value report. The system includes a server comprising an electronic processor and computer readable memory accessible by the processor. The server operates upon execution of a program to provide a vehicle value report by receiving a vehicle identity at the server; transmitting a request for vehicle sensor data to a vehicle identified by the received vehicle identity; receiving the vehicle sensor data from the identified vehicle via a wireless carrier system; accessing from the memory standard vehicle data values for vehicles within a vehicle group that includes the identified vehicle; constructing a vehicle value report which includes information that is based on a comparison of the received vehicle sensor data with the standard vehicle data values; and electronically transmitting the vehicle value report to a requesting entity.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flow chart depicting an embodiment of a method of creating a telematics-based vehicle value report; and

FIG. 3 is a block diagram depicting a portion of the communications system shown in FIG. 1 and an embodiment of a subset of vehicles in a particular group of similar vehicles.

### DETAILED DESCRIPTION OF THE ILLUSTRATED EMBODIMENTS

The system and method described below may be used to generate telematics-based vehicle value reports using vehicle sensor data received from production vehicles during their use in service by individuals and fleet owners. The received vehicle sensor data is accessed and/or stored at the vehicle and reported back wirelessly using a vehicle telematics unit. This enables automated creation of a complete vehicle value report that provides an accurate, objective basis for vehicle valuation, whether for use by a prospective purchaser of the vehicle, a dealership for resale, an insurance company for evaluating claims, or even a fractional ownership arrangement that is based on a pay-as-you-go or pay-how-you-drive valuation.

The vehicle sensor data collected and used for the vehicle value report may include such categories of data as vehicle usage data, vehicle maintenance data, and vehicle collision data, as well as any other vehicle data that may be recorded at the vehicle and later used to assess the vehicle's condition and current value. This assessment may be done using the vehicle sensor data by comparing it to standard vehicle data values for vehicles within the same group. For this purpose, a vehicle group can include a large number of vehicles that heterogeneously vary by such characteristics as manufacturer, model, production year, or trim level, to provide a few examples. Any one or a combination of these characteristics can be used as a common identifier to define a vehicle group. For instance, a particular model of vehicle classified by a manufacturer as part of a particular model year can be used to define a vehicle group. Once the vehicle group has been determined, a central facility can generate a set of standard vehicle data values either in real time or over a period of time by wirelessly requesting vehicle sensor data from at least a subset of vehicles in the group. The vehicles can each send the requested sensor data from vehicle telematics units to the central facility where it can be aggregated and averaged or otherwise processed into the standard vehicle data values for the identified group of vehicles.

Later, an interested party, such as a vehicle dealer or prospective vehicle purchaser, can request a verified vehicle value report for one or more of the vehicles in the subset. This vehicle value report is verified in the sense that it is produced directly from data recorded automatically and obtained electronically from the telematics unit. The central facility can receive a vehicle identity, such as a VIN, from a requesting party for a vehicle of interest. The central facility can then obtain vehicle sensor data from the vehicle telematics unit of the particular vehicle represented by the vehicle identity. After receiving the requested vehicle sensor data from the particular vehicle, the central facility can compare the received vehicle sensor data to standard vehicle data values and build a message (the report) that is based on the comparison and that may include the vehicle sensor data from the particular vehicle of interest, the standard vehicle data values, or both. It is also possible to incorporate vehicle sensor data that has been previously stored at the central facility into the verified vehicle value report for the particular vehicle of interest. Before receiving the request for the verified vehicle value report, the central facility may monitor and store vehicle sensor data for vehicles in the vehicle group. Later, after receiving the identity of a particular vehicle in that group, the central facility can access the previously-received vehicle sensor data for that vehicle and include it in the vehicle value report. The requesting party receiving the message thereby receives a vehicle value report that provides verified, meaningful, comparative data on the particular vehicle relative to other similar vehicles.

### Communications System

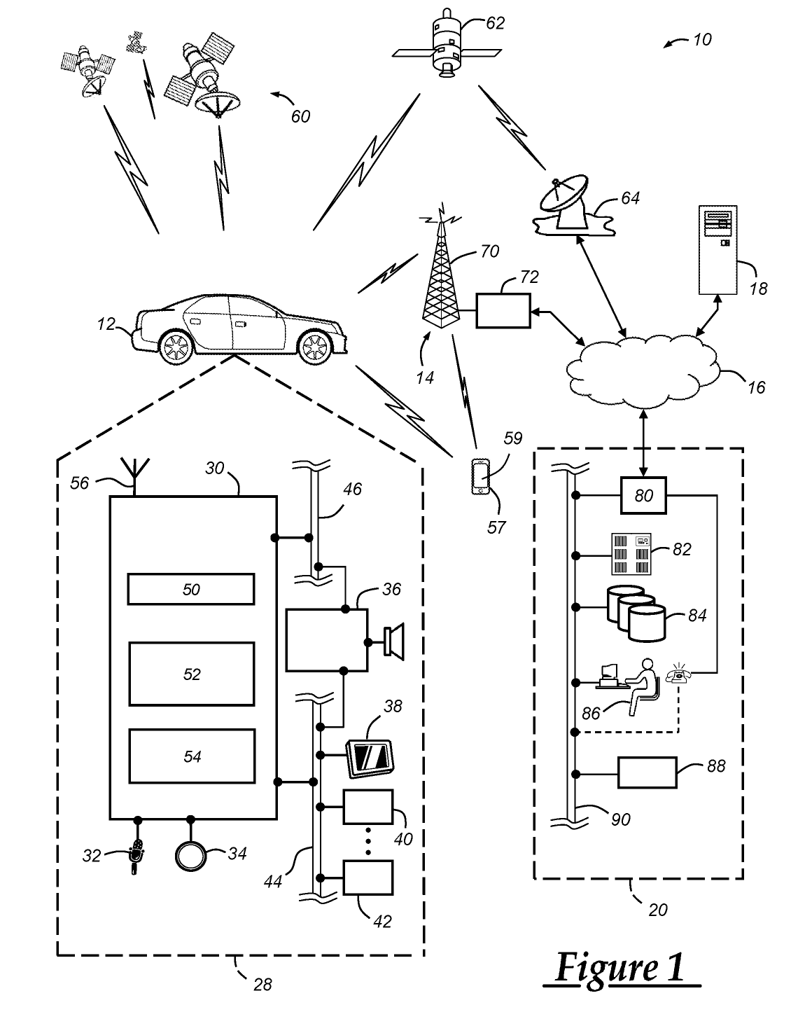

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

One of the networked devices that can communicate with the telematics unit 30 is a wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. The smart phone 57 also includes one or more microprocessors that execute machine code to generate logical output. Examples of the smart phone 57 include the iPhone manufactured by Apple and the Galaxy manufactured by Samsung, as well as others. While the smart phone 57 may include the ability to communicate via cellular communications using the wireless carrier system 14, this is not always the case. For instance, Apple manufactures devices such as the various models of the iPad and iPod Touch that include the processing capability, the display 59, and the ability to communicate over a short-range wireless communication link. However, the iPod Touch™ and some iPads™ do not have cellular communication capabilities. Even so, these and other similar devices may be used or considered a type of wireless device, such as the smart phone 57, for the purposes of the method described herein.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. The term VSM can be considered to have a similar meaning as vehicle sensor. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. The VSM 42 can also be implemented as an accelerometer that measures the rate of change of vehicle velocity. These accelerometers can be implemented as 3-axis accelerometers that are known to those skilled in the art. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000 or 1xEV-DO) or GSM/GPRS (e.g., 4G LTE). As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 includes an electronic processor and computer-readable memory accessible by the processor for such things as data and computer program storage. The computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method

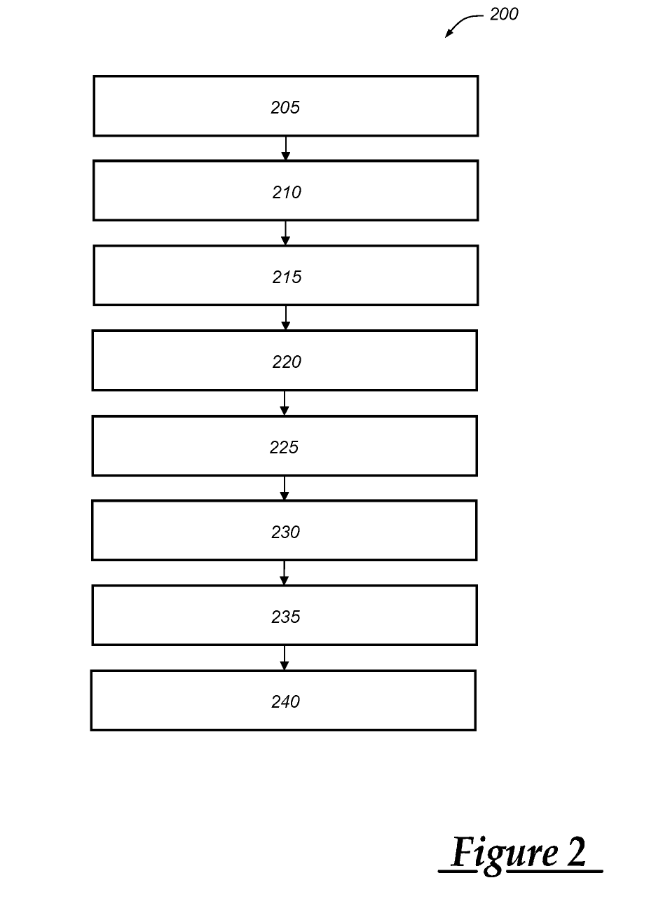

Turning now to FIG. 2, there is shown an exemplary implementation of a method 200 of creating and providing a telematics-based vehicle value report. The method 200 may be implemented using the communication system 10 of FIG. 1; for example, by carrying out various steps using computer 18 and/or server 82 at the call center 20. The method 200 may be used to obtain vehicle sensor data (i) from a large subset of vehicles within a particular vehicle group for the purpose of generating standard vehicle data values, and (ii) from individual vehicles upon request for the purpose of creating a vehicle value report.

The method begins at step 205 wherein a vehicle group is identified using a common identifier such that the identifier may then be used to associate a particular vehicle with the vehicle group. This association may be used for purposes of gathering data from many vehicles to generate the standard vehicle data values for the vehicle group, or to analyze vehicle sensor data from a specific vehicle relative to those standard values. The vehicle value report can be generated based on a comparison of the vehicle sensor data from the particular vehicle of interest with standard vehicle data values derived from vehicle sensor data from many other similar vehicles. The common identifier permits the vehicle sensor data to be compared to that of like vehicles; that is, other vehicles within the same vehicle group. The vehicle group can include a heterogeneous mix of vehicles assembled by the same or different manufacturers, for different production years, and in different standard or optional equipment packages or configurations; the configurations can include models, trim levels, or engine sizes, for example. In some embodiments, the common identifier may comprise a portion of the vehicle's vehicle identification number (VIN) indicating model, engine type, model year, and can include non-VIN information such as to identify specific equipment packages or geographic regions of use.

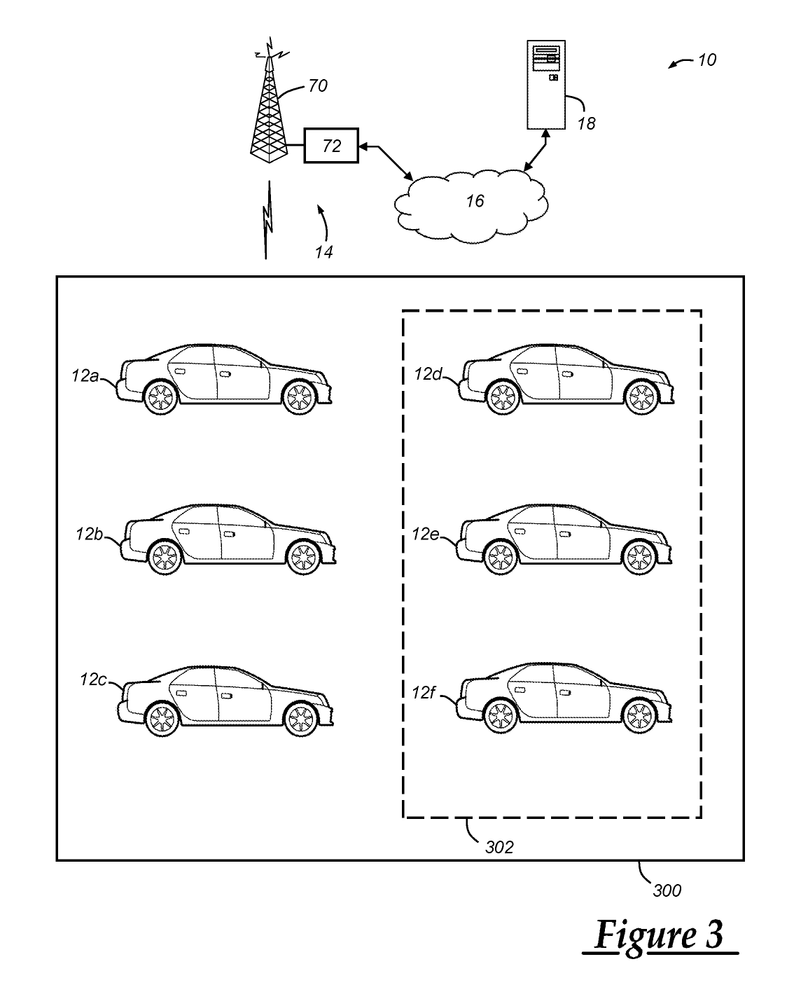

Referring briefly to FIG. 3, there is shown a vehicle group 300 in which a subset 302 of the vehicle group 300 is shown with dashed lines. The subset 302 is shown as including vehicles 12a-12c from the vehicle group 300 comprising vehicles 12a-12g. While only six vehicles are shown in the vehicle group 300, it should be appreciated this number is for illustrative purposes only and the group may include thousands or more vehicles. In one example, the subset 302 of vehicles in the group could be manufactured by General Motors™ under the brand Chevrolet™ for model year (MY) 2014 as Impala™ models having the 3.6 liter V6 engine. This configuration is one example of the basis of a common identifier.

A central facility, such as the computer 18 or call center 20, can then use the common identifier to request vehicle sensor data from all of the group 300 or just a subset 302 of vehicles represented by the common identifier. And an amount and identity of the vehicle sensor data can be included in the request. Vehicle sensor data can include categories of information related to vehicle maintenance, vehicle usage, and vehicle collisions. Vehicle maintenance may involve how the vehicle has been maintained. For example, vehicle sensors can maintain oil life values that represent an oil quality measurement or the useful life of the oil used by the vehicle engine. The vehicle sensors can maintain the oil life value at the vehicle 12 and store the oil life value when the oil is changed and the oil life value is reset. The oil life values can be scored from 0-100 with 100 representing newly-changed oil and 0 representing little to no service life left in the engine oil. Other vehicle maintenance sensor data can include diagnostic trouble codes (DTCs) that vehicle on-board diagnostics generate and store at the vehicle 12. Vehicle sensor data also includes vehicle odometer readings indicating current mileage of the vehicle as well as past mileage values on past dates.

Vehicle sensor data relating to vehicle usage can include information indicating hard acceleration, hard braking, and speed. The vehicles can include accelerometers that measure the rate of change of vehicle velocity and record those measurements over time. The processor 52 of the vehicle telematics unit 30 can record maximum acceleration/deceleration values that the vehicle 12 has experienced as vehicle sensor data. These acceleration/deceleration values can describe how forcefully the vehicle 12 has stopped or accelerated, which may provide a general indication of the condition of the vehicle braking system and vehicle engine/transmission, respectively. The vehicle 12 can also include vehicle sensors that measure vehicle speed and record the speeds the vehicle 12 has reached. In some implementations, the vehicle 12 can calculate an average speed of the vehicle and also provide maximum speed values. The vehicle can monitor vehicle speed over a period of time and calculate an average vehicle speed that may be stored at the vehicle 12. Vehicle collisions can be indicated by sudden stops detected using output from the accelerometer or by detecting whether or not airbags have deployed. Other vehicle sensor data relating to vehicle usage can include the total number of hours a vehicle engine has been operational. The data from these various sensors are available to the telematics unit 30 over the communication bus 44, and their integration into the vehicle electronics 28 as part of different VSMs and the messaging used to send the data over the bus 44 will be known to those skilled in the art.

It should be appreciated that the central facility can maintain a database that includes a history of vehicle sensor data obtained from all of the vehicles in the vehicle group 300. The central facility can then associate the history of vehicle sensor data received from each vehicle with a unique vehicle identifier that identifies one particular vehicle, such as a VIN. The history of vehicle sensor data comprises data that is received prior to a request for a vehicle value report and can include vehicle maintenance history. To create the history of vehicle sensor data, the central facility can periodically contact the vehicles and request vehicle sensor data. After receiving the vehicle sensor data from the vehicles, the central facility can store the vehicle sensor data for each vehicle with the unique vehicle identifier thereby establishing a centrally-located repository of vehicle usage history. The method 200 proceeds to step 210.

At step 210, requests are generated at the central facility for the vehicle(s) from which vehicle sensor data is desired. This may be a single request to a single vehicle to obtain vehicle sensor data for use in generating a vehicle value report, or multiple requests to the subset 302 of vehicles in the vehicle group 300. In this embodiment, the central facility will be described as being implemented by the computer 18. However, other implementations can use the call center 20 or some other central facility to carry out the disclosed methods. The computer 18 can maintain a database of vehicle identifiers that may be associated with wireless contact information. The vehicle identifiers can include identifying information describing vehicles. For example, the vehicle identifiers can be VINs that indicate the general characteristics of the vehicle as well as a clear identification of individual vehicles. VINs can identify the vehicle's production year, the manufacturer, the model, engine type, options, and other information. In this regard, a production year may be a particular model year assigned by the manufacturer, or may be the year in which the vehicle was manufactured. The computer 18 can determine the information included in the common identifier and compare that information to vehicles in the database. The computer 18 can identify all of the VINs of vehicles that have the configurations, such as models, trim levels, or engine sizes, that are identified by the common identifier. The computer 18 can access wireless contact information associated with the vehicles/VINs and generate a computer-readable instruction requesting vehicle sensor data. This instruction can be included in a message sent to the vehicles. The computer-readable instruction can also identify the vehicle sensor data to provide. Continuing the example presented above, the subset 302 of MY 2014 Chevrolet™ Impala™ vehicles having the 3.6 liter V6 engine can be directed by the instruction to provide information related to vehicle maintenance, vehicle usage, and vehicle collisions depending on which categories of vehicle sensor data the instruction includes. The method 200 proceeds to step 215.

At step 215, requests for vehicle sensor data are wirelessly transmitted from the computer 18 to the vehicle(s) and the one or more categories of vehicle sensor data are wirelessly received back from the vehicle(s) via the wireless carrier system 14. When the computer readable instruction is received by a vehicle, the vehicle obtains the vehicle sensor data identified by the instruction from onboard the vehicle using vehicle sensors or by accessing on-board memory. For example, the vehicle telematics unit 30 in the vehicles can read the computer-readable instruction and then direct one or more VSMs 42 to provide vehicle data values for the identified vehicle sensor data. The vehicle telematics unit 30 can also access previously-stored vehicle sensor data from the memory device 54. The vehicle sensor data can then be incorporated with a data message and wirelessly sent to the computer 18 from the telematics unit via the wireless carrier system 14. In one example, a vehicle receiving the messages from the computer 18 obtains current mileage data as well as historical mileage data recorded each month. It may also obtain historical GPS location data indicating the areas of a country or region in which the vehicle has been operated. The vehicle telematics unit(s) 30 can access previously-stored maximum speed values from the memory device 54, the maximum accelerometer values, or both. DTCs and oil life values can also be obtained and included with the data message. In some embodiments, this includes stored information that contains a history of the particular sensor data since the originally delivery of the vehicle to its first customer. In this way, a complete profile of the vehicle use, maintenance, and accidents may be automatically provided by the telematics unit when requested. In some implementations, the vehicle telematics unit 30 provides vehicle sensor data acquired by the vehicle 12 without further processing. However, the vehicle telematics unit 30 can process the vehicle sensor data before incorporation into the data message in some implementations. For example, average vehicle speeds can be calculated by the processor 52 included on the vehicle telematics unit 30 and the result of that calculation can be incorporated in the data message. The method 200 proceeds to step 220.

At step 220, one or more standard vehicle data values are generated for the received vehicle sensor data. This step would not typically be done as a part of a requested vehicle sensor data from a single vehicle for purposes of an individual vehicle value report, but would be done as a part of initially building the database of standard vehicle data values to be used the system when generating vehicle value reports. However, the standard values may be continuously updated during use of the system, and data received from an individual vehicle for purposes of a vehicle value report may be averaged or otherwise factored in to the calculated standard vehicle data values.

The computer 18 can calculate the standard values for vehicle sensor data related to vehicle maintenance, vehicle usage, and vehicle collisions for the vehicles included in the subset 302. These standard vehicle data values represent baseline values, typical values, or ranges of values for the vehicle sensor data received from the identified vehicle. The standard values can be averages, means, or other values or ranges representing a common level of vehicle sensor data gathered for a particular category of vehicle information. Baseline values may be values indicating a threshold or minimum desired or acceptable value for a particular parameter. As one example, the baseline value for oil change history may be that each oil change was performed prior to the remaining oil life decreasing to 0%. Or any acceleration greater than a baseline of 0.5 g and deceleration greater than a baseline of 0.7 g may be considered excessive acceleration and braking, respectively. Variations from those baselines may be indicated on the vehicle value report. Typical values of vehicle sensor data may represent averages for certain parameters among all of the vehicles polled for the particular vehicle group. For example, a standard vehicle data value for average monthly miles driven might be calculated by averaging the total miles driven over time from each such vehicle in the group 300 that reported its mileage data.

Thus, using the example described above for 2014 Chevrolet™ Impala™ models having the 3.6 liter V6 engine, the subset 302 of those vehicles in the vehicle group 300 can be quantified by the average speeds those vehicles drive, the average maximum starting and stopping acceleration values, the average oil life values before oil changes, the frequency of DTCs and the identity of DTCs, and airbag deployments. These standard vehicle data values generated by the computer 18 can be used by prospective purchasers of vehicles in the subset 302 who can compare it with vehicle sensor data from individual vehicles when shopping for vehicles. The vehicle sensor data gathered from a particular vehicle can be compared next to the standard vehicle data values detected for the subset 302 of vehicles similar to the particular vehicle. This will be discussed in more detail below. The method 200 proceeds to step 225.

At step 225, a vehicle identity for a vehicle of interest is received at the computer 18. The interested party can identify the vehicle of interest and provide the identity to the computer 18. The interested party can enter the VIN of the vehicle of interest into the smart phone display 59 of smart phone 57. The smart phone 57 can wirelessly transmit the VIN of the vehicle of interest to the computer 18. The computer 18 can access a database in which the VIN is stored with vehicle contact information, such as a mobile dialed number (MDN). It is also possible to provide other types of information that identifies the vehicle of interest. For example, the interested party can directly provide the MDN for the vehicle telematics unit 30 that the computer 18 can use to contact the vehicle and gather vehicle sensor data from it.

In addition to identifying the vehicle of interest, the vehicle sensor data to be acquired can also be identified. For example, the interested party may want to access information relating to vehicle usage, vehicle maintenance, and vehicle driving. Or in some implementations, the interested party may only want to access information about vehicle accidents. The interested party can identify the category/amount of vehicle sensor data to be accessed when the vehicle identity is provided. And while the entry of vehicle information or VINs is described using the smart phone 57, it is also possible to do so using a personal computer (PC) that is communicably linked via the Internet to the computer 18. The computer 18 can first identify the proper vehicle group that have features common with the vehicle of interest. In some instances, the computer 18 has already obtained vehicle sensor data for the group 300 to which the identified vehicle belongs. Other times, the computer 18 may have to obtain the vehicle sensor data after receiving the information about the vehicle of interest. In that case, the computer 18 can carry out steps 205-220 described above to accomplish this. Otherwise, the method 200 proceeds to step 230.

At step 230, a request for vehicle sensor data is wirelessly transmitted to the vehicle of interest identified by the received vehicle identity and the vehicle sensor data is received from the vehicle of interest via the wireless carrier system 14. The computer 18 can use the MDN for the vehicle of interest to contact that vehicle and send it a request for the identified vehicle sensor data much like is described above with respect to step 215. The method proceeds to step 235.

At step 235, standard vehicle data values are accessed at the computer 18 for the vehicle group 300 from which the vehicle of interest is included. The group 300 described above includes 2014 Chevrolet™ Impala™ models having the 3.6 liter V6 engine. Assuming the vehicle of interest is within this group, the computer 18 can access the standard vehicle data values for that group 300. If the vehicle of interest is included in a different vehicle group, the computer 18 can access the standard vehicle data values associated with that other group. The standard vehicle data values for a particular group can be stored at the computer 18 or at a different location, remotely located from and accessible by the computer 18. The method 200 proceeds to step 240.

At step 240, a vehicle value report is constructed that includes information based on a comparison of the vehicle sensor data for the vehicle of interest with the standard vehicle data values for the group 300. This may include different groups of reported data including: (1) an identification of any active trouble codes (DTCs) along with a brief explanation of that code; (2) an oil history indicating the extent to which oil changes were made according to the proper maintenance schedule; (3) mileage information such as the average monthly miles driven along with a comparison to monthly miles driven by other drivers of the vehicles in the same group; (4) driving usage history indicating the presence or absence of unusual driving habits such as excessive hard engine use, excessive hard braking, excessive acceleration, excessive speeding; (5) miles or time spent driving in different geographic regions, for example, by a country map colored by region according to the amount of driving in each such region; and (6) accident history information indicating whether there has been any accelerometer-based detection of a collision or whether any airbag deployments have occurred. In some implementations, the vehicle value report can also a history of vehicle sensor data for the vehicle of interest that has been previously-received by and stored at the central facility.

The vehicle value report can then be electronically transmitted from the computer 18 to the requesting party (e.g., prospective purchaser, dealership, or other interested party). The vehicle value report can be constructed as an electronic message that is formatted to present the results of the comparison of the vehicle's sensor data with the standard vehicle data values, and may alternatively or additionally include at least some of that vehicle sensor data as well as at least some of the standard vehicle data values for the group 300. The vehicle value report can be formatted into discrete visual sections that address vehicle maintenance, vehicle usage, and vehicle accidents for presentation on a visual display 59 of the smart phone 57 or a visual display peripheral of a PC. For example, the six numbered groups of reported data identified above may each be placed into separate regions of the report. The vehicle value report may be displayed in response to the smart phone 57 or PC receiving a discrete electronic message that includes the vehicle sensor data for the vehicle of interest as well as the standard vehicle data values for the subset 302. Some implementations may involve hosting the vehicle value report at the computer 18 such that the prospective purchaser or interested party can remotely access the report using the smart phone 57 or PC.

In addition to or in lieu of the report information described above, the vehicle value report may include a header identifying and/or depicting (e.g., using a photo) the vehicle of interest and provide a brief description of the vehicle in terms of the group to which it belongs and is being compared. The vehicle maintenance section of the vehicle value report can present the median, average, or lowest oil life value from the vehicle of interest next to the average, median, or lowest oil life value received from the subset 302 of vehicles in the group. It can also identify if any warranty work has been done on the vehicle or if warranty work should be done but has not. The vehicle usage section can also present the maximum acceleration and deceleration values for the vehicle of interest along with an average or median maximum acceleration and deceleration values for the subset 302. The vehicle accident section can indicate how many times, if any, that the vehicle of interest has activated its airbags or detected a collision based on accelerometer values. The vehicle value report described above represents one implementation of such a message and it should be appreciated that other configurations of the vehicle usage, maintenance, and accident information are possible. The method 200 then ends.

In at least some embodiments, participation of the vehicle in the method 200 may be initiated only following, and only in response to, authorization by the vehicle purchaser or lessee that permits the collection and use of the vehicle sensor data. This may be part of a program or service offered by the vehicle manufacturer or other telematics service provider.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing a telematics-based vehicle value report, comprising the steps of:
(a) receiving a vehicle identity at a central facility;
(b) wirelessly transmitting a request for vehicle sensor data to a vehicle identified by the received vehicle identity via a wireless carrier system;
(c) wirelessly receiving the vehicle sensor data from the identified vehicle via the wireless carrier system;
(d) accessing, at a central facility, standard vehicle data values for vehicles within a vehicle group that includes the identified vehicle, wherein the standard vehicle data values represent baseline values, typical values, or ranges of values for the vehicle sensor data received from the identified vehicle;
(e) constructing a vehicle value report which includes information that is based on a comparison of the received vehicle sensor data with the standard vehicle data values; and
(f) electronically transmitting the vehicle value report to a requesting entity.

2. The method of claim 1, further comprising the step of receiving selections for one or more categories of vehicle sensor data along with the vehicle identity.

3. The method of claim 1, wherein the vehicle sensor data comprises vehicle collision data, vehicle usage data, vehicle maintenance data, or any combination of vehicle collision data, vehicle usage data, and vehicle maintenance data.

4. The method of claim 1, wherein the vehicle value report is formatted into individual sections each associated with a category of vehicle sensor data.

5. The method of claim 1, wherein the standard vehicle data values are associated in a database according to a common identifier.

6. The method of claim 1, wherein the vehicle group is defined at least in part by manufacturer, model, production year, or any combination of the manufacturer, model, and production year.

7. The method of claim 1, wherein step (f) comprises sending the vehicle value report as a discrete electronic message.

8. The method of claim 1, wherein step (f) comprises providing access to the vehicle value report from the central facility.

9. The method of claim 1, further comprising the step of identifying categories of vehicle sensor data based on the vehicle identity.

10. The method of claim 1, wherein the vehicle value report further comprises historical vehicle sensor data for the vehicle identified by the received vehicle identity.

11. A method of providing a telematics-based vehicle value report, comprising the steps of:
(a) identifying from a vehicle group a subset of vehicles based on a common identifier;
(b) generating requests at a central facility for one or more categories of vehicle sensor data;
(c) wirelessly transmitting the requests from the central facility to the subset of vehicles;
(d) wirelessly receiving the one or more categories of vehicle sensor data from at least some of the subset of vehicles via the wireless carrier system;
(e) generating one or more standard vehicle data values from the received vehicle sensor data, wherein the standard vehicle data values represent baseline values, typical values, or ranges of values for the vehicle sensor data received from the identified vehicle;
(f) constructing a vehicle value report which includes information that is based on a comparison of the received vehicle sensor data with the standard vehicle data values; and
(g) electronically transmitting the vehicle value report from the central facility to a requesting entity.

12. The method of claim 11, further comprising the step of receiving selections for one or more categories of vehicle sensor data.

13. The method of claim 11, wherein the categories of vehicle sensor data comprise vehicle collision data, vehicle usage data, and vehicle maintenance data.

14. The method of claim 11, wherein the typical vehicle sensor data values are associated in a database according to the common identifier.

15. The method of claim 11, wherein the subset is defined at least in part by manufacturer, model, production year, or any combination of the manufacturer, model, and production year.

16. The method of claim 10, wherein step (g) comprises sending the vehicle value report as a discrete electronic message.

17. The method of claim 10, wherein step (g) comprises providing access to the vehicle value report from the central facility.

18. The method of claim 10, further comprising the step of identifying the one or more categories of vehicle sensor data based on a vehicle identity.

19. The method of claim 10, wherein the vehicle value report further comprises historical vehicle sensor data for one or more vehicles included in the vehicle group.

20. A system for providing a telematics-based vehicle value report, comprising:
a server comprising an electronic processor and computer readable memory accessible by the processor, wherein the server operates upon execution of a program to provide a vehicle value report by carrying out the following steps:
(a) receiving a vehicle identity at the server;
(b) transmitting a request for vehicle sensor data to a vehicle identified by the received vehicle identity;
(c) receiving the vehicle sensor data from the identified vehicle via a wireless carrier system;
(d) accessing from the memory standard vehicle data values for vehicles within a vehicle group that includes the identified vehicle, wherein the standard vehicle data values represent baseline values, typical values, or ranges of values for the vehicle sensor data received from the identified vehicle;
(e) constructing a vehicle value report which includes information that is based on a comparison of the received vehicle sensor data with the standard vehicle data values; and
(f) electronically transmitting the vehicle value report to a requesting entity.
